(19) United States
(12) Patent Application Publication
(10) Pub. No.: US 2022/0001696 A1
(43) Pub. Date: Jan. 6, 2022

(54) STEEL WIRE AND TIRE

(71) Applicants: SUMITOMO ELECTRIC TOCHIGI CO., LTD., Tochigi (JP); SUMITOMO ELECTRIC INDUSTRIES, LTD., Osaka (JP)

(72) Inventors: Akifumi MATSUOKA, Tochigi (JP); Shinei TAKAMURA, Osaka (JP)

(21) Appl. No.: 17/294,001

(22) PCT Filed: Oct. 24, 2019
(86) PCT No.: PCT/JP2019/041742

§ 371 Date: May 14, 2021

(51) Int. Cl. B60C 9/00; B32B 1/00; B32B 15/01; B21F 45/00

(52) U.S. Cl. CPC B60C 9/0007; B32B 1/00; B60C 2009/0014; B21F 45/00; B32B 15/015

(57) ABSTRACT

A steel wire having a flat shape in a cross-section perpendicular to a longitudinal direction, wherein an outer shape of the cross-section includes a first straight portion, a second straight portion arranged opposite to the first straight portion, and a first curved portion and a second curved portion that connect the first straight portion to the second straight portion, wherein the first curved portion is arranged opposite to the second curved portion, and wherein a ratio of W1 to W2 is 75% or less, where W1 is an average value of a length of the first straight portion and a length of the second straight portion, and W2 is a maximum distance between the first curved portion and the second curved portion.

### TECHNICAL FIELD

The present disclosure relates to a steel wire and a tire.

This patent application is based on and claims priority to Japanese Patent Application No. 2018-229035 filed on Dec. 6, 2018, the entire contents of which are incorporated herein by reference.

### BACKGROUND ART

In Patent Document 1, in a pneumatic radial tire, in which a side reinforcement layer, in which a plurality of single steel wires are arranged and are embedded in rubber, is disposed in an area from a bead to a sidewall, a pneumatic radial tire in which the single steel wire has a flat shape, the flattening of the single steel wire is from 40% to 70%, the long diameter of the single steel wire is 0.80 mm or less, an average interval of the multiple single steel wires is 0.60 mm or more, and the product of the buckling load of each single steel wire and the mass of the wire per an unit area of the side reinforcement layer is 400 N·kg/m2 or more, is proposed.

### RELATED ART DOCUMENTS

### Patent Documents

[Patent Document 1] Japanese Laid-open Patent Publication No. 2015-178301

### SUMMARY OF THE INVENTION

A steel wire according to the present disclosure has a flat shape in a cross-section perpendicular to a longitudinal direction, wherein an outer shape of the cross-section includes a first straight portion, a second straight portion arranged opposite to the first straight portion, and a first curved portion and a second curved portion that connect the first straight portion to the second straight portion, wherein the first curved portion is arranged opposite to the second curved portion, and wherein a ratio of W1 to W2 is 75% or less, where W1 is an average value of a length of the first straight portion and a length of the second straight portion, and W2 is a maximum distance between the first curved portion and the second curved portion.

### BRIEF DESCRIPTION OF THE DRAWINGS

FIG. 1 is a cross-sectional view of a steel wire according to one aspect of the present disclosure in a plane perpendicular to a longitudinal direction;

FIG. 2 is an explanatory drawing of a rolling device used when the steel wire according to one aspect of the present disclosure is manufactured;

FIG. 3 is a cross-sectional view of a tire according to one aspect of the present disclosure;

FIG. 4 is a drawing schematically illustrating a belt layer; and

FIG. 5 is an explanatory drawing of a durability test in an experimental example.

### EMBODIMENT FOR CARRYING OUT THE INVENTION

### Problem to Be Solved by the Present Disclosure

According to the invention disclosed in Patent Document 1, the rolling resistance of a pneumatic radial tire can be reduced by using a single steel wire instead of a steel cord made by twisting multiple filaments together as a reinforcement wire material of a side reinforcement layer to reduce the amount of used coating rubber.

In recent years, however, further improvement in performance of tires is desired. Thus, with respect to tires, in addition to weight reduction for reducing the rolling resistance, for example, improvement in durability is desired in order to reduce the frequency of replacing tires and use tires for a longer period of time. Then, with respect to a steel wire used for a tire, there is demand for a steel wire that can form a tire superior in a lightweight property and durability.

Therefore, it is an object to provide a steel wire that can form a tire superior in a lightweight property and durability.

### Effect of the Present Disclosure

According to the present disclosure, a steel wire that can form a tire superior in a lightweight property and durability can be provided.

[Description of Embodiments of the Present Disclosure]

First, embodiments of the present disclosure will be described by listing. In the following description, the same or corresponding elements are referenced by the same reference signs and the same descriptions will not be repeated for the same or corresponding elements.

(1) A steel wire according to one aspect of the present disclosure has a flat shape in a cross-section perpendicular to a longitudinal direction, wherein an outer shape of the cross-section includes a first straight portion, a second straight portion arranged opposite to the first straight portion, and a first curved portion and a second curved portion that connect the first straight portion to the second straight portion, wherein the first curved portion is arranged opposite to the second curved portion, and wherein a ratio of W1 to W2 is 75% or less, where W1 is an average value of a length of the first straight portion and a length of the second straight portion, and W2 is a maximum distance between the first curved portion and the second curved portion.

The steel wire may be disposed, for example, in a belt layer of a tire. The belt layer includes a steel wire and a rubber, and the steel wire is embedded within the rubber. The thickness of the belt layer can be selected so as to embed the steel wire in the rubber. Thus, a shape of the cross-section of the steel wire is formed in a flat shape to reduce the thickness of the steel wire, thereby reducing the thickness of the belt layer. Thus, by using a steel wire of which the shape of the cross-section is a flat shape, the amount of rubber included in the belt layer can be reduced in comparison with, for example, a case of using a steel wire having a circular shape and the same cross-sectional area. Therefore, by using a steel wire of which the shape of the cross-section is a flat shape, the weight of the belt layer can be reduced and the weight of the tire including the belt layer can also be reduced.

Further, according to the studies of the inventor of the present invention, it was found that by setting the ratio of W1 to W2 described above to 75% or less, the durability of the steel wire can be improved, and the durability of the tire using the steel wire can also be improved. It is conceivable that this is because, by setting the ratio of W1 to W2 to 75% or less, when the shape of the cross-section of the steel wire is processed into a flat shape, the formation of cracks at a boundary between a position to which compressing processing is applied and a position to which tensile processing is applied can be suppressed. The ratio of W1 to W2 can be calculated by (the ratio of W1 to W2 (%))=W1/W2×100.

Therefore, according to the steel wire according to one aspect of the present disclosure, a steel wire that can form a tire superior in a lightweight property and durability can be formed.

(2) The ratio of the W1 to the W2 may be 60% or greater.

(3) A flattening that is a ratio of a thickness to W2 may be 60% or greater, the thickness being a maximum distance between the first straight portion and the second straight portion.

Here, the flattening can be calculated by (the flattening (%))=T/W2×100, where T is the thickness.

(4) The flattening that is the ratio of the thickness to W2 may be 80% or less, the thickness being the maximum distance between the first straight portion and the second straight portion.

(5) The thickness may be 0.30 mm or greater, the thickness being the maximum distance between the first straight portion and the second straight portion.

(6) The thickness may be 0.50 mm or less, the thickness being the maximum distance between the first. straight portion and the second straight portion.

(7) A brass plating film containing Cu and Zn may be included.

Here, Cu indicates copper, and Zn indicates zinc.

(8)The brass plating film described above may further contain one or more elements selected from Co and Ni.

Here, Co indicates cobalt, and Ni indicates nickel.

(9) A tire including a steel wire as described in any of (1) to (8) may be formed.

[Details of Embodiment of the Present Disclosure]

Specific examples of a steel wire and a tire according to one embodiment of the present disclosure (which is hereinafter referred to as “the present embodiment”) will be described below with reference to the drawings. It should be noted that the present invention is not limited to these examples and is intended to include all modifications in the meaning and within the scope of the claims and equivalents.

[Steel Wire]

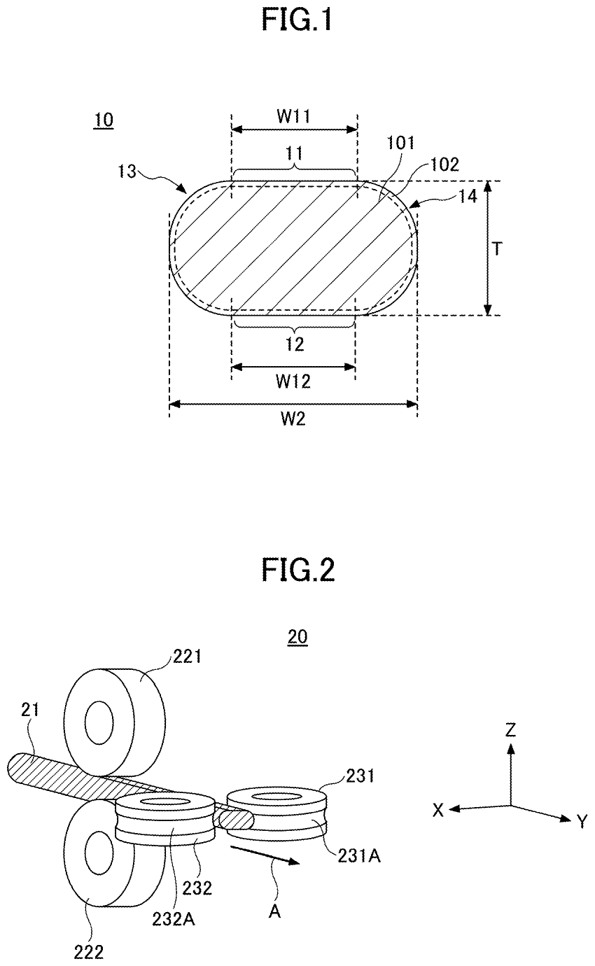

In the following, the steel wire according to the present embodiment will be described with reference to FIG. 1.

FIG. 1 illustrates a cross-sectional view of a steel wire 10 according to the present embodiment in a plane perpendicular to a longitudinal direction.

The steel wire 10 of the present embodiment may be referred to as one wire, that is, a single wire, and a single steel wire. The steel wire 10 of the present embodiment is preferably not twisted along the longitudinal direction and is preferably a straight steel wire.

As illustrated in FIG. 1, the steel wire 10 of the present embodiment may have a flattened cross-sectional shape perpendicular to the longitudinal direction. The flat shape indicates, for example, a flat shape having a thickness shorter than the width. Hereinafter, a cross-section perpendicular to the longitudinal direction of the steel wire is simply referred to as the “cross-section”.

The steel wire may be disposed, for example, in a belt layer of a tire. The belt layer includes the steel wire and rubber, and the steel wire is embedded in the rubber, as will be described later in the description of the tire. The thickness of the belt layer can be selected so as to embed the steel wire in the rubber. Thus, a shape of the cross-section of the steel wire is formed in a flat shape to reduce the thickness of the steel wire, thereby reducing the thickness of the belt layer. Thus, by using a steel wire of which the shape of the cross-section is a flat shape, the amount of rubber included in the belt layer can be reduced in comparison with, for example, a case of using a steel wire having a circular shape and the same cross-sectional area. Therefore, by using a steel wire of which the shape of the cross-section is a flat shape, the weight of the belt layer can be reduced and the weight of the tire including the belt layer can also be reduced.

However, according to the studies of the inventors of the present invention, if the shape of the cross-section is a flat shape, the durability of the steel wire may be insufficient. For example, if the steel wire is repeatedly deformed by applying external force, the steel wire may be broken with a small number of deformations. Thus, the inventors of the present invention further examined a steel wire that can achieve both weight reduction and durability of a tire when the steel wire is used in the tire. As a result, it was found that by making a shape of the cross-section of the steel wire be a predetermined flat shape, the durability of the steel wire can be improved, and the lightweight property and the durability of the tire using the steel wire can be improved.

As illustrated in FIG. 1, an outer shape of the cross-section of the steel wire 10 of the present embodiment includes a first straight portion 11 and a second straight portion 12 arranged opposite to the first straight portion 11. Additionally, the outer shape of the cross-section of the steel wire 10 of the present embodiment may include a first curved portion 13 and a second curved portion 14 that connect the first straight portion 11 to the second straight portion 12.

The first straight portion 11 is preferably parallel to the second straight portion 12 as illustrated in FIG. 1. In this context, “parallel” does not indicate being parallel in a strict sense, but indicates that the two straight portions are arranged in parallel.

As illustrated in FIG. 1, the first curved portion 13 is arranged opposite to the second curved portion 14. Each of the first curved portion 13 and the second curved portion 14 may be configured to connect an end of the first straight portion 11 to an end of the second straight portion 12, and a shape of each of the first curved portion 13 and the second curved portion 14 is not particularly limited. For example, as illustrated in FIG. 1, each of the first curved portion 13 and the second curved portion 14 may have a shape convex toward the outside of the steel wire 10.

A ratio of W1 to W2 is preferably 75% or less, and more preferably 72% or less, where W1 is the average value of a length W11 of the first straight portion 11 and a length W12 of the second straight portion 12, and W2 is the maximum distance between the first curved portion 13 and the second curved portion 14. Here, W2 as described above indicates the longest distance between the first curved portion 13 and the second curved portion 14, and may be referred to as the width of the steel wire 10.

The length W11 of the first straight portion 11, the length W12 of the second straight portion 12, and the maximum distance W2 between the first curved portion 13 and the second curved portion 14 are preferably averages of values measured at multiple cross-sections perpendicular to the longitudinal direction of the steel wire, respectively, in order to avoid the effect of variation in the shape of the cross-section of the steel wire. The length W11 of the first straight portion 11, the length W12 of the second straight portion 12, and the maximum distance W2 between the first curved portion 13 and the second curved portion 14 are more preferably averages of values measured at three cross-sections perpendicular to the longitudinal direction of the steel wire, for example. When W11, W12, and W2 are measured at multiple cross-sections perpendicular to the longitudinal direction of the steel wire and averages are calculated, it is preferable that a distance between adjacent cross-sections is sufficient. Although it depends on the length of a test piece of the steel wire, the distance between adjacent cross-sections is preferably 1 cm or greater and 5 cm or less, for example.

W1 described above can be calculated by W1=(W11+W12)/2. The ratio of W1 to W2 can be calculated by (the ratio of W1 to W2 (%))=W1/W2×100.

The steel wire of which the shape of the cross-section is a flat shape can be formed, for example, by rolling a steel wire of which the shape of the cross-section is a circular shape. The first straight portion 11 and the second straight portion 12 described above are formed when a steel wire of which the shape of the cross-section is a circular shape is rolled.

In order to increase the average value W1 of the length W11 of the first straight portion 11 and the length W12 of the second straight portion 12 to approach the maximum distance W2 between the first curved portion 13 and the second curved portion 14, the pressure applied during rolling is required to be increased to make the shape of the cross-section of the steel wire be a flat shape.

However, if the pressure applied during rolling is excessively increased in order to obtain a flat shape and the above-described ratio of W1 to W2 is increased, it is assumed that cracks occur at a boundary, within the steel wire, between a position to which compressing processing is applied and a position to which tensile processing is applied, thereby causing the durability of the steel wire to decrease.

With respect to the above, according to the studies of the inventors of the present invention, it is found that by setting the ratio of W1 to W2 to 75% or less as described above, the durability of the steel wire can be increased and the durability of the tire using the steel wire can also be increased. It is conceivable that this is because, by setting the ratio of W1 to W2 to 75% or less, the formation of cracks at the boundary between the position to which compressing processing is applied and the position to which tensile processing is applied, when the steel wire is processed so that the shape of the cross-section becomes a flat shape, can be suppressed.

The lower limit value of the ratio of W1 to W2 is not particularly limited, but, for example, the lower limit is preferably 60% or greater, and is more preferably 62% or greater. By setting the ratio of W1 to W2 to 60% or greater, residual stress, caused by a processing difference between a thickness direction and a width direction of the steel wire, and the occurrence of wire deformation of a twist in a spiral shape, caused by a difference in surface hardness, can be suppressed. Therefore, because handling property is superior, the productivity can be increased if the steel wire is used for a tire and the like.

The specific size of W1, being the average value of the length W11 of the first straight portion 11 and the length W12 of the second straight portion 12 of the steel wire according to the present embodiment, is not particularly limited, and may be selected as desired in accordance with, for example, the size of the steel wire that is not processed into a flat shape yet. For example, W1 is preferably 0.25 mm or greater and 0.36 mm or less, and more preferably 0.27 mm or greater and 0.36 mm or less.

Additionally, the specific size of the maximum distance W2 between the first curved portion 13 and the second curved portion 14 of the steel wire 10 of the present embodiment, that is, the specific size of the width of the steel wire 10 of the present embodiment, is not particularly limited. The maximum distance W2 between the first curved portion 13 and the second curved portion 14 of the steel wire 10 of the present embodiment is, for example, preferably 0.42 mm or greater and 0.52 mm or less, and more preferably 0.43 mm or greater and 0.50 mm or less.

The flattening of the steel wire 10 of the present embodiment is not particularly limited, but is preferably 60% or greater. Here, the flattening is a ratio of the thickness T, being the maximum distance between the first straight portion 11 and the second straight portion 12, to the maximum distance W2 between the first curved portion 13 and the second curved portion 14, and can be calculated by (the flattening (%))=T/W2×100. The maximum distance between the first straight portion 11 and the second straight portion 12 indicates the longest distance between the first straight portion 11 and the second straight portion 12, and may be defined as the thickness of the steel wire 10 as described above.

Similarly with W11, W12, and W2 previously described, the thickness T is preferably an average of values measured at multiple cross-sections perpendicular to the longitudinal direction of the steel wire. In particular, the thickness T is more preferably an average of values measured at three cross-sections perpendicular to the longitudinal direction of the steel wire. If the thickness T is measured at three cross-sections perpendicular to the longitudinal direction of the steel wire to calculate the average, the distance between adjacent sections is preferably 1 cm or greater and 5 cm or less, although it depends on the length of a test piece of the steel wire.

According to the studies of the inventors of the present invention, this is because by setting the flattening to 60% or greater, the durability of the steel wire can be particularly improved. It is conceivable that by setting the flattening to 60% or greater, the formation of cracks at the boundary between the position to which compressing processing is applied and the position to which tensile processing is applied can be suppressed when the steel wire is processed so that the shape of the cross-section of the steel wire becomes a flat shape. The flattening is more preferably 63% or greater.

Additionally, the upper limit of the flattening is not particularly limited, but is preferably 80% or less, and is more preferably 75% or less.

This is because by setting the flattening to 80% or less, the thickness of the steel wire can be particularly suppressed, and the thickness of the belt layer is particularly suppressed when the steel wire is used in the tire, which is preferable. Additionally, this is because by setting the flattening to 80% or less, residual stress caused by processing difference between a thickness direction and a width direction of the steel wire and the occurrence of a wire deformation of a twist in a spiral shape caused by the difference in surface hardness can be particularly suppressed and handling performance is superior, so that the productivity can be increased if the steel wire is used for the tire and the like.

The thickness of the steel wire of the present embodiment is not particularly limited, but is preferably 0.30 mm or greater and more preferably 0.32 mm or greater.

This is because by setting the thickness T of the steel wire to 0.30 mm or greater, the durability of the steel wire can be particularly improved.

The upper limit of the thickness T of the steel wire is not particularly limited, but is, for example, preferably 0.50 mm or less, and more preferably, 0.42 mm or less. This is because by setting the thickness T of the steel wire to 0.50 mm or less, when the steel wire is used in the tire, the thickness of the belt layer in which the steel wire is disposed and the amount of rubber included in the belt layer can be suppressed, thereby reducing the weight of the belt layer using the steel wire and the tire including the belt layer.

The thickness T of the steel wire is the maximum distance between the first straight portion 11 and the second straight portion 12 as described above.

Although the material of the steel wire in the present embodiment is not particularly limited, the steel wire of the present embodiment may have a configuration of a steel wire 101 and a plating film 102 disposed on the surface of the steel wire 101, for example, as illustrated in FIG. 1.

As the steel wire, a high carbon steel wire may be suitably used.

The plating film may be a plating film in which metal components are only copper (Cu) and zinc (Zn), for example, that is, a brass plating film, but may further contain a metal component other than Cu and Zn. The plating film may further contain, for example, one or more elements selected from cobalt (Co) and nickel (Ni) as a metal component.

That is, the steel wire of the present embodiment may include a brass plating film containing, for example, Cu and Zn. The brass plating film may also further contain one or more elements selected from Co and Ni. Here, the brass plating film may be disposed, for example, on the surface of the steel wire as described above.

The steel wire of the present embodiment may include a brass plating film containing Cu and Zn, so that the adhesion between the steel wire and the rubber can be increased and the durability of the tire can be particularly improved, if the steel wire is covered with rubber to form the tire. Additionally, the brass plating film may further contain one or more elements selected from Co and Ni, so that the adhesion between the steel wire and the rubber can be further increased and the durability of the tire can be further improved, which is preferable.

The method of manufacturing the steel wire of the present embodiment is not particularly limited, but the steel wire may be manufactured such that the shape of the cross-section thereof is the previously described shape.

The method of manufacturing the steel wire according to the present embodiment may include, for example, the following processes.

An unprocessed steel wire preparation process of preparing an unprocessed steel wire of which the shape of the cross-section perpendicular to the longitudinal direction is a circular shape

A first rolling process of providing the unprocessed steel wire to a pair of first rolling rollers whose compression surfaces are opposite, and compressing the unprocessed steel wire along a first axial direction parallel to a diameter in a cross-section perpendicular to the longitudinal direction of the unprocessed steel wire

A second rolling process of providing the unprocessed steel wire after the first rolling process between a pair of second rolling rollers whose compression surfaces are opposite, and compressing the unprocessed steel wire along a second axial direction orthogonal to the first axial direction in the cross-section perpendicular to the longitudinal direction of the unprocessed steel wire

The first rolling process and the second rolling process may be performed, for example, by a rolling device 20 illustrated in FIG. 2.

The rolling device 20 includes a pair of first rolling rollers 221 and 222 whose compression surfaces are opposite, and the pair of first rolling rollers 221 and 222 can compress an unprocessed steel wire 21 in a first axial direction parallel to the diameter of the cross-section of the unprocessed steel wire 21, for example, along the thickness direction. In the rolling device 20 illustrated in FIG. 2, the first axial direction corresponds to the Z-axis direction, and the first pair of the first rolling rollers 221 and 222 can compress the unprocessed steel wire 21 in the up and down direction along the Z-axis direction of FIG. 2 to perform the above-described first rolling process.

In the first rolling process, the pair of first rolling rollers 221 and 222 compresses and rolls the unprocessed steel wire 21 to form the first straight portion 11 and the second straight portion 12 in the cross section of the steel wire 10 illustrated in FIG. 1. Thus, the pair of first rolling rollers 221 and 222 preferably includes flat portions corresponding to the first straight portion 11 and the second straight portion 12 in the compression surfaces, that is, surfaces to contact the unprocessed steel wire 21, respectively.

The rolling device 20 may include a pair of second rolling rollers 231 and 232 on a downstream side in a conveying direction of the unprocessed steel wire 21 from the pair of first rolling rollers 221 and 222. The pair of second rolling rollers 231 and 232 can compress the unprocessed steel wire 21 on which the first rolling process has been performed, along a second axial direction orthogonal to the first axial direction of the cross-section of the unprocessed steel wire 21, that is, for example, the width direction. In the rolling device 20 illustrated in FIG. 2, the second axial direction corresponds to the X-axis direction, and the pair of second rolling rollers 231 and 232 can compress the unprocessed steel wire 21 on which the first rolling process has been performed, from the left and right direction along the X-axis direction illustrated in FIG. 2 to perform the second rolling process described above. In this context, “orthogonal” does not indicate being orthogonal in a strict sense, but indicates being substantially orthogonal, including a certain amount of the error.

In the second rolling process, the pair of the second rolling rollers 231 and 232 compresses and rolls the unprocessed steel wire 21 on which the first rolling process has been performed, so that the first curved portion 13 and the second curved portion 14 in the cross-section of the steel wire 10 illustrated in FIG. 1 can be formed. Thus, the pair of second rolling rollers 231 and 232 preferably includes shapes corresponding to the first curved portion 13 and the second curved portion 14 in compression surfaces, that is, surfaces to contact the unprocessed steel wire 21, respectively. The second rolling rollers 231 and 232 may respectively include grooves 231A and 232A having shapes corresponding to the first curved portion 13 and the second curved portion 14 in a shape of a cross-section in a plane passing through the central axes of the second rolling rollers 231 and 232.

In the first rolling process and the second rolling process, the degree of compressing and rolling can be adjusted so as to satisfy the shape of the cross-section of the steel wire of the present embodiment previously described.

Then, the unprocessed steel wire 21 is conveyed in the direction indicated by the arrow A in FIG. 2, that is, along the Y-axis direction, and the first rolling process and the second rolling process described above are performed on an entirety in the longitudinal direction thereof, so that the steel wire of the present embodiment can be manufactured.

Here, a configuration example used in a method of manufacturing the steel wire of the present embodiment has been described with the example in which the first rolling process and the second rolling process are performed. However, the present invention is not limited to such a configuration. For example, in a case where the shape of the cross-section can be formed in the previously described shape only by the first rolling process, the second rolling process may be omitted.

[Tire]

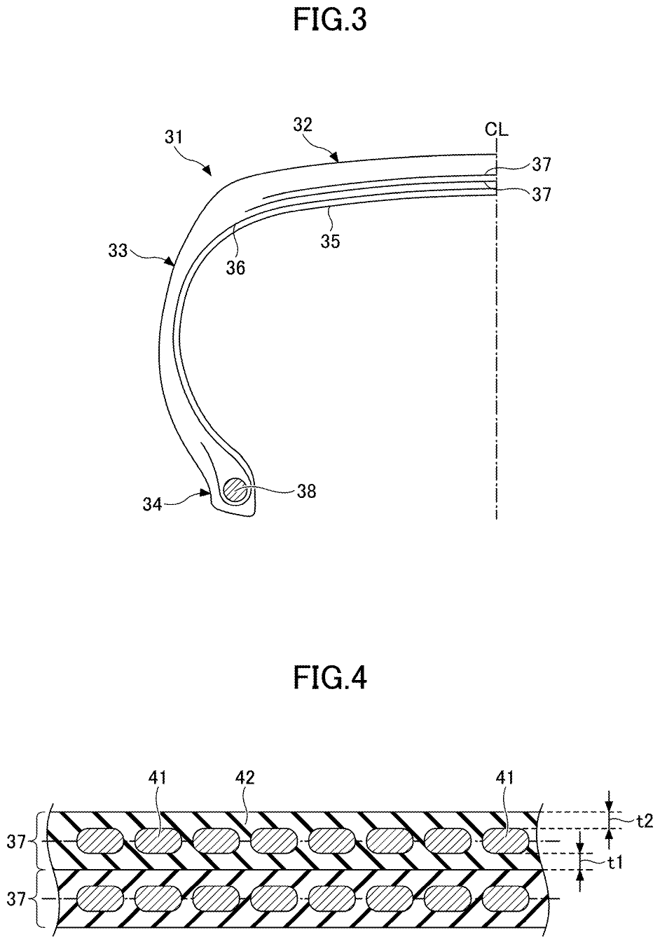

Next, a tire according to the present embodiment will be described with reference to FIG. 3 and FIG. 4.

The tire of the present embodiment may include the steel wire previously described.

FIG. 3 illustrates a cross-sectional view in a plane perpendicular to a circumferential direction of a tire 31 according to the present embodiment. FIG. 3 illustrates only the left part from the centerline (CL), but the right part from the CL continuously has a similar structure by using the CL as a symmetry axis.

As illustrated in FIG. 3, the tire 31 includes a tread 32, a sidewall 33, and a bead 34.

The tread 32 is a portion that is in contact with a road surface. The bead 34 is provided toward the inside of the tire 31 from the tread 32. The bead 34 is a portion that is in contact with a rim of a wheel of a vehicle. The sidewall 33 connects the tread 32 to the bead 34. When the tread 32 is impacted through the road surface, the sidewall 33 is elastically deformed to absorb the impact.

The tire 31 includes an inner liner 35, a carcass 36, a belt layer 37, and a bead wire 38.

The inner liner 35 is formed of rubber and seals a space between the tire 31 and the wheel.

The carcass 36 forms a backbone of the tire 31. The carcass 36 is formed of an organic fiber, such as polyester, nylon, and rayon, or a steel wire; and rubber.

The bead wire 38 is provided in the bead 34. The bead wire 38 receives a tensile force acting on the carcass.

The belt layers 37 tighten the carcass 36 to increase the rigidity of the tread 32. In the example illustrated in FIG. 7, the tire 31 includes two belt layers 37.

FIG. 4 is a drawing schematically illustrating the two belt layers 37. FIG. 4 illustrates a cross-sectional view in a longitudinal direction of the belt layer 37, that is, in a plane perpendicular to the circumferential direction of the tire 31.

As illustrated in FIG. 4, the two belt layers 37 are overlapped with each other in a radial direction of the tire 31. Each belt layer 37 includes multiple steel wires 41 and rubber 42. Multiple steel wires 41 are arranged in parallel in a row. As the steel wire 41, the steel wire previously described may be used.

Here, the steel wire previously described has a flat shape in the cross-section perpendicular to the longitudinal direction, and the steel wires are preferably arranged to align the thickness direction of the belt layer with the thickness direction of the steel wire. Thus, for example, the steel wires 10 previously described are preferably arranged so that the first straight portion 11 and the second straight portion 12 of the steel wire 10 are along the width direction of the belt layer.

The rubber 42 covers the steel wires 41, and the full circumference of each steel wire 41 is covered with the rubber 42. The steel wires 41 are embedded in the rubber 42.

The steel wire previously described has a flat shape in the cross-section perpendicular to the longitudinal direction. Thus, even if a first rubber thickness t1 of the rubber 42 disposed under the steel wire 41 in the belt layer 37, and a second rubber thickness t2 of the rubber 42 disposed above the steel wire 41 in the belt layer 37, are reduced, exposure of the steel wire 41 can be prevented. Thereby, the overall thickness of the belt layer 37 can be reduced. As described, according to the tire of the present embodiment, the overall thickness of the belt layer 37 including the steel wire 41 previously described can be reduced, thereby reducing the weight of the belt layer 37. Therefore, the weight of the tire of the present embodiment including such a belt layer can be reduced, thereby suppressing the rolling resistance of the tire.

The durability of the steel wire previously described is improved. Therefore, the durability of the tire of the present embodiment that uses such a steel wire can be improved.

Although the embodiment has been described in detail above, the present invention is not limited to the specific embodiment, and various modifications and alterations can be made within the scope of the claims.

### EXAMPLES

Specific examples will be described below. However, the present invention is not limited to these examples.

### (Evaluation Method)

A method of evaluating the steel wire produced in the following experimental examples will be described.

### (1) Method of Evaluating the Shape of the Cross-Section of the Steel Wire

The obtained steel wires were embedded in a transparent resin and a sample was cut out to expose a plane (i.e., a cross section) perpendicular to the longitudinal direction of the steel wire.

Then, the length and distance of each portion in such a cross-section were measured using a projector.

The length and distance of each portion were measured in three cross-sections, and averages of values of length and distance of each portion measured in the three cross-sections were defined as the length and the distance of each portion of the steel wire. Positions of the three cross-sections used for measurement were set such that a distance between adjacent cross-sections was 5 cm.

Specifically, the length W11 of the first straight portion 11 and the length W12 of the second straight portion 12 were measured in three cross-sections, and the average values were determined as W11 and W12 of the steel wire 10 of each experimental example. In addition, the average value W1 of W11 and W12 was calculated.

The thickness T that is the maximum distance between the first straight portion 11 and the second straight portion 12 was measured in three cross-sections, and the average value was determined as the thickness T of the steel wire 10 of each experimental example.

The maximum distance W2 between the first curved portion 13 and the second curved portion 14, that is, the width of the steel wire 10, was measured in three cross-sections, and the average value was defined as the width of the steel wire 10 of each experimental example.

Then, the ratio of W1 to W2 was calculated by the following expression from W1 and W2 described above.

(the ratio of W1 to W2 (%))=W1/W2×100

The flattening was calculated by the following equation from the thickness T and the width that is the maximum distance W2 between the first curved portion 13 and the second curved portion 14 that were measured and calculated.

(flattening (%))=T/W2×100

### (2)Durability Test

The steel wire made in each of the following experimental examples was placed on a rubber sheet and further covered with a rubber sheet. Then, a laminate of a rubber sheet having a rectangular shape and a steel wire was prepared. The laminate had a total thickness that is five times greater than the thickness of the steel wire. The laminate of the rubber sheet and the steel wire was vulcanized at 160° C. for 20 minutes.

After spontaneous cooling, a test piece formed in a string shape, including the steel wire, was removed with a cutter knife from the obtained steel wire and rubber complex. The shape of the cross-section of the test piece formed in a string shape was 5 mm thick and 10 mm wide.

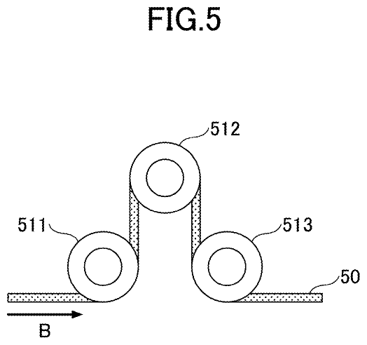

As illustrated in FIG. 5, the obtained test piece 50 was processed by a first roller 511, a second roller 512, and a third roller 513, having a roller diameter of 25 mm. At this time, as illustrated in FIG. 5, positions of respective rollers were adjusted so that the test piece 50 positioned between the first roller 511 and the second roller 512 and the test piece 50 positioned between the second roller 512 and the third roller 513 were parallel. Additionally, a load of 29.4 N is applied to the test piece 50 being processed by the first roller 511 to the third roller 513 along the longitudinal direction. Then, with an operation, in which the first roller 511 to the third roller 513 were rotated to move the test piece 50 in the direction of the arrow B in FIG. 5, and, then, the first roller 511 to the third roller 513 were rotated in the reverse direction to move the test piece 50 in a direction opposite to the arrow B, being performed as a set, the operation was repeated. The rotational speed was set for each roller so that 100 sets of the reciprocating movement described above can be performed in a minute. The number of sets of the reciprocating movement of the test piece was then counted until the test piece fractured.

The durability is higher as the number of sets of the reciprocating movement described above increases. Evaluation results were shown with an index using the number of sets of the reciprocating movement described above of the test piece until the test piece fractured in Experimental Example 6 as 100.

### (3)Weight Index

In evaluating the weight index, a rubber sheet was produced using the steel wire produced in each of the following experimental examples.

A rubber composition is based on natural rubber as a rubber component and contains carbon black, sulfur, zinc oxide, organic acid cobalt, and cobalt stearate as additives.

The steel wire and the rubber composition, produced in each of the experimental examples, were used to produce a rubber sheet having the same structure as the belt layer 37 illustrated in FIG. 4.

Then, the weight of the rubber sheet produced using the steel wire in each of the experimental examples was shown with an index using the weight of a rubber sheet produced using a steel wire having a circular cross-section and a wire diameter of 0.415 mm, prepared as the unprocessed steel wire in each of the following experimental examples, as 100.

### (Experimental Examples)

In the following, experimental conditions will be described. Experimental Example 1 to Experimental Example 5 are embodiments, and Experimental Example 6 and

Experimental Example 7 are comparative examples.

### Experimental Example 1

An unprocessed steel wire 21 having a wire diameter of 0.415 mm and a circular cross-sectional shape was prepared (i.e., the unprocessed steel wire preparation process). The unprocessed steel wire 21 has a structure in which a brass plating film made of Cu and Zn as metal components is disposed on a surface of the high carbon steel wire.

The unprocessed steel wire was provided to the rolling device 20 illustrated in FIG. 2 and was processed to have a predetermined cross-sectional shape illustrated in FIG. 1.

As previously described, the rolling device 20 includes the pair of first rolling rollers 221 and 222 whose compression surfaces are opposite, and the unprocessed steel wire 21 was provided between the pair of first rolling rollers 221 and 222. Then, the pair of first rolling rollers 221 and 222 compressed the unprocessed steel wire 21 along the Z-axis direction in FIG. 2, that is, along the thickness direction of the unprocessed steel wire 21 in the up and down direction (i.e., the first rolling process). The pair of first rolling rollers 221 and 222 having flat portions, corresponding to the first straight portion 11 and the second straight portion 12, formed on the respective compression surfaces, was used.

As illustrated in FIG. 2, the pair of the second rolling rollers 231 and 232 was disposed at the downstream side from the pair of the first rolling rollers 221 and 222 in the conveying direction of the unprocessed steel wire 21, and the unprocessed steel wire 21 on which the first rolling process had been performed was provided between the pair of the second rolling rollers 231 and 232.

Then, the pair of the second rolling rollers 231 and 232 compressed the unprocessed steel wire 21, on which the first rolling process had been performed, along the X-axis direction in FIG. 2, that is, along the width direction of the unprocessed steel wire 21 in the left and right direction (i.e., the second rolling process). In a shape of a cross-section in a plane passing through the central axes of the second rolling rollers 231 and 232, the pair of the second rolling rollers 231 and 232, including the grooves 231A and 232A having shapes that correspond to the first curved portion 13 and the second curved portion 14, formed on the respective pressing surface, was used.

Then, the unprocessed steel wire 21 was conveyed along the arrow A in FIG. 2, and the first rolling process and the second rolling process described above were performed on the entirety in the longitudinal direction thereof, so that the steel wire of the present experimental example was produced.

In the first rolling process and the second rolling process, the degree of compressing and rolling was adjusted so that the thickness T of the steel wire was 0.34 mm, W1 was 0.28 mm, and W2 was 0.44 mm.

The obtained steel wire was evaluated as previously described. Evaluation results are shown in Table 1.

### Experimental Example 2 to Experimental Example 7

Steel wires were produced and evaluated in the same manner of Experimental Example 1 except that the degree of compressing and rolling was adjusted so that the thickness T, W1, and W2 were equal to the values shown in Table 1 in the first rolling process and the second rolling process.

Evaluation results are shown in Table 1.

TABLE 1

| | | EXPERI- | EXPERI- | EXPERI- | EXPERI- | EXPERI- | EXPERI- | EXPERI- |
|---|---|---|---|---|---|---|---|---|
| | | MENTAL | MENTAL | MENTAL | MENTAL | MENTAL | MENTAL | MENTAL |
| | | EXAMPLE 1 | EXAMPLE 2 | EXAMPLE 3 | EXAMPLE 4 | EXAMPLE 5 | EXAMPLE 6 | EXAMPLE 7 |
| THICKNESS T | (mm) | 0.34 | 0.32 | 0.30 | 0.30 | 0.29 | 0.28 | 0.28 |
| W1 | (mm) | 0.28 | 0.32 | 0.35 | 0.35 | 0.37 | 0.39 | 0.40 |
| W2 | (mm) | 0.44 | 0.47 | 0.49 | 0.48 | 0.52 | 0.51 | 0.52 |
| RATIO OF | (%) | 64 | 68 | 71 | 73 | 71 | 76 | 77 |
| W1 TO W2 | | | | | | | | |
| FLATTENING | (%) | 77 | 68 | 61 | 63 | 56 | 55 | 54 |
| DURABILITY | (—) | 113 | 111 | 108 | 104 | 101 | 100 | 100 |
| WEIGHT INDEX | (—) | 97 | 95 | 92 | 91 | 92 | 90 | 91 |

According to the results shown in Table 1, it is found that in Experimental Example 1 to Experimental Example 5 in which the ratio of W1 to W2 is 75% or less, the durability is improved in comparison with Experimental Example 6 and Experimental Example 7. It is conceivable that this is because the ratio of W1 to W2 is 75% or less, so that, when the shape of the cross-section of the steel wire is formed in a flat shape, the formation of cracks at the boundary between the position to which compressing processing is applied and the position to which tensile processing is applied can be suppressed, thereby improving the durability of the steel wire. The evaluation of the durability is performed using the test piece in which the steel wire is embedded in in the rubber, and it is fully expected that the durability can be similarly improved if the tire uses such a steel wire.

Furthermore, it was found that by using a tire using a steel wire of Experimental Example 1 to Experimental Example 5, the weight of the tire can be reduced by up to 10 % in comparison with the rubber sheet using a steel wire having a circular cross-sectional shape that is not processed into a flat shape yet.

From these results, it is confirmed that the steel wires of Experimental Example 1 to Experimental Example 5 can be used to form tires superior in a lightweight property and durability.

### DESCRIPTION OF THE REFERENCE NUMERALS

10 steel wire
101 steel wire
102 plating film
11 first straight portion
12 second straight portion
13 first curved portion
14 second curved portion
T Thickness
W11 length of the first straight portion
W12 length of the second straight portion
W2: maximum distance between the first curved portion and
the second curved portion
20 rolling device
21 unprocessed steel wire
221, 222 first rolling roller
231, 232 second rolling roller
231A, 232A groove
31 tire
32 tread
33 sidewall
34 bead
35 inner liner
36 carcass
37 belt layer
38 bead wire
41 steel wire
42 rubber
t1 first rubber thickness
t2 second rubber thickness
50 test piece
511 first roller
512 second roller
513 third roller

1. A steel wire having a flat shape in a cross-section perpendicular to a longitudinal direction,
wherein an outer shape of the cross-section includes a first straight portion, a second straight portion arranged opposite to the first straight portion, and a first curved portion and a second curved portion that connect the first straight portion to the second straight portion,
wherein the first curved portion is arranged opposite to the second curved portion, and
wherein a ratio of W1 to W2 is 75% or less, where W1 is an average value of a length of the first straight portion and a length of the second straight portion, and W2 is a maximum distance between the first curved portion and the second curved portion.

2. The steel wire as claimed in claim 1, wherein the ratio of W1 to W2 is 60% or greater.

3. The steel wire as claimed in claim 1, wherein a flattening is 60% or greater, the flattening being a ratio of a thickness to W2, and the thickness being a maximum distance between the first straight portion and the second straight portion.

4. The steel wire as claimed in claim 1,
wherein a flattening is 80% or less, the flattening being a ratio of a thickness to W2, and the thickness being a maximum distance between the first straight portion and the second straight portion.

5. The steel wire as claimed in claim 1, wherein a thickness is 0.30 mm or greater, the thickness being a maximum distance between the first straight portion and the second straight portion.

6. The steel wire as claimed in claim 1, wherein a thickness is 0.50 mm or less, the thickness being a maximum distance between the first straight portion and the second straight portion.

7. The steel wire as claimed in claim 1, comprising a brass plating film containing Cu and Zn.

8. The steel wire as claimed in claim 7, wherein the brass plating film further contains one or more elements selected from Co and Ni.

9. A tire comprising the steel wire as claimed in claim 1.
